(19) United States
(12) Patent Application Publication
(10) Pub. No.: US 2011/0206168 A1
(43) Pub. Date: Aug. 25, 2011

(54) CHANNEL ESTIMATOR

(75) Inventors: Hidehiro Matsuoka, Kanagawa (JP); Tatsuhisa Furukawa, Kanagawa (JP); Masami Aizawa, Kanagawa (JP); Jun Mitsugi, Kanagawa (JP)

(73) Assignee: KABUSHIKI KAISHA TOSHIBA, Tokyo (JP)

(21) Appl. No.: 12/883,636

(22) Filed: Sep. 16, 2010

(30) Foreign Application Priority Data
Feb. 25, 2010 (JP) 2010-040629

(51) Int. Cl. H04B 1/10

(52) U.S. Cl. 375/346

(57) ABSTRACT

According to an embodiment, a channel estimator includes a channel response estimation section configured to estimate a channel response by correlation processing between a received signal and a known pattern signal; a path power calculation section configured to measure power of each path within an output of the channel response estimation section; a noise power calculation section configured to measure noise power from the output of the channel response estimation section; a path determination section configured to determine paths to be preserved by using the path power outputted from the path power calculation section and the noise power outputted from the noise power calculation section; and a noise removal section configured to remove values in time domain excepting the paths determined at the path determination section, from the output of the channel response estimation section.

### CROSS-REFERENCE TO RELATED APPLICATION(S)

This application is based upon and claims the benefit of priority from Japanese Patent Application No. 2010-040629 filed in Japan on Feb. 25, 2010; the entire contents of which are incorporated herein by reference.

### FIELD

Embodiments described herein relate to a channel estimator which enables the improvement of the estimation accuracy of channel response.

### BACKGROUND

In wide-band radio communication and terrestrial broadcasting systems, a radio signal originated from a transmission station/broadcast station is distorted due to multi-pathing. Therefore, it is important to reduce demodulation errors by equalizing the distorted signal at a receiver. Generally, a distortion component generated at a multi-path channel can be represented by using a channel impulse response (delay profile) which represents the propagation delay, amplitude attenuation, phase rotation of each path in the time domain, or a channel frequency response which represents the frequency characteristics of amplitude and phase in the frequency domain. Therefore, at a receiver, achieving a sufficient level of equalization of signal distortion is dependent on how accurately such channel response can be estimated.

For example, in a band-limited single-carrier communication scheme, in addition to data signals, a known sequence called a unique word and a pilot signal, etc. is often time-multiplexed and, at a receiver, a channel impulse response is estimated by a sliding correlator or a matched filter which utilizes such known sequence. Hereafter, a channel impulse response in the time domain is abbreviated simply as a channel response.

By the way, when such channel response estimation is performed, estimation error from the true channel response often becomes large due to thermal noises of the receiver, pseudo noises caused by the autocorrelation characteristics of the known sequence and the cross correlation characteristics between the known sequence and the data sequence, the effects of band limitation, and so on.

Regarding such problem, there is a conventional art for improving the estimation accuracy of the channel response.

However, while in a conventional channel estimator, noise removal is performed by determining a threshold value in various ways to improve estimation accuracy, such method of determining the threshold value, which depends on the level of path or the level difference between paths in the channel response, has a problem that all the paths to be preserved cannot be sufficiently picked up when the S/N ratio of received signal is good, or noise components cannot be sufficiently suppressed when the S/N ratio is poor, resulting in a deterioration of the estimation accuracy of the channel response.

### BRIEF DESCRIPTION OF THE DRAWINGS

FIG. 1 is a block diagram to illustrate the configuration of a channel estimator relating to a first embodiment of the present invention;

FIG. 2 is a diagram to illustrate the concept of path determination in the channel estimator relating to the first embodiment of the present invention;

FIG. 3 is a block diagram to illustrate the configuration of a channel estimator relating to a second embodiment of the present invention;

FIG. 4 is a diagram to illustrate the concept of path group determination in the channel estimator relating to the second embodiment of the present invention;

FIG. 5 is a block diagram to illustrate the configuration of a channel estimator relating to a third embodiment of the present invention;

FIG. 6 is a flowchart to illustrate the control of the channel estimator relating to the third embodiment of the present invention;

FIGS. 7A and 7B are diagrams representing channel responses before and after changing a symbol synchronization timing, where FIG. 7A represents a channel response before the change, and FIG. 7B represents a channel response after the change;

FIG. 8 is a block diagram to illustrate another configuration example of the channel estimator relating to the third embodiment of the present invention;

FIGS. 9A to 9C are diagrams to illustrate the background art of the third embodiment of the present invention, where FIG. 9A shows one frame, and one symbol duration in a data section thereof, FIG. 9B shows an enlarged view of the portion of the one symbol duration in the data section of FIG. 9A, and FIG. 9C shows variation within the one symbol period;

FIG. 10 is a block diagram illustrating the background art of the third embodiment of the present invention;

FIG. 11 is a diagram to illustrate a path residue window in a channel estimator of a conventional art example; and

FIG. 12 is a block diagram indicating the configuration of a receiver relating to the embodiments of the present invention.

### DETAILED DESCRIPTION

According to an embodiment to be described herein, a channel estimator includes:

a channel response estimation section configured to estimate a channel response by correlation processing between a received signal and a known pattern signal;

a path power calculation section configured to measure power of each path within an output of the channel response estimation section;

a noise power calculation section configured to measure noise power from the output of the channel response estimation section;

a path determination section configured to determine paths to be preserved by using the path power outputted from the path power calculation section and the noise power outputted from the noise power calculation section; and

a noise removal section configured to remove values in time domain excepting the paths determined at the path determination section, from the output of the channel response estimation section.

Hereafter, embodiments of the present invention will be described in detail with reference to the drawings.

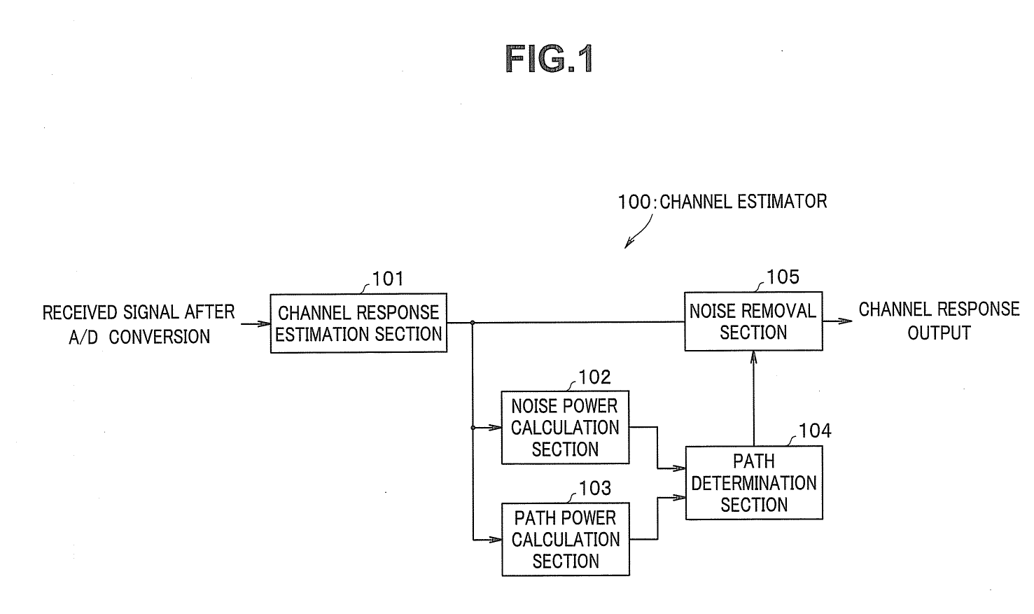

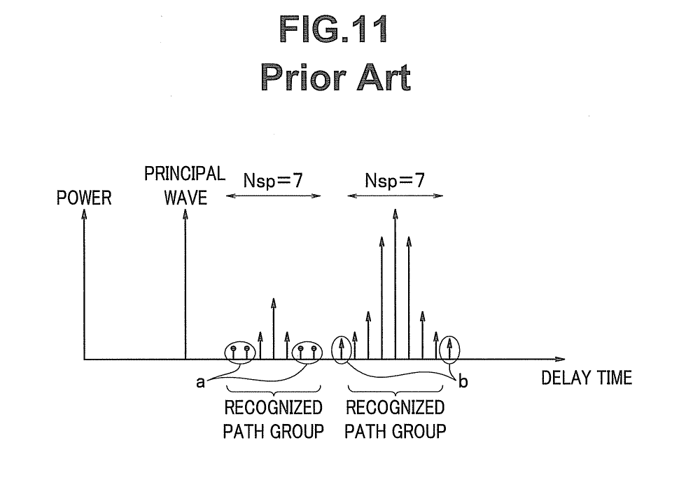

Before describing the embodiments of the present invention in FIGS. 1 to 10 and FIG. 12, a path residue window in a channel estimator of a conventional art example will be described with reference to FIG. 11.

In the conventional art example, attention is paid to a problem that in an environment where paths exist adjacent to each other, because of widening of an impulse response caused by band limitation, sidelobe components of a path interfere with the channel response estimation values of adjacent paths. And as a countermeasure thereof, as shown in FIG. 11, a “multi-path sampling method” is proposed in which Nsp channel response estimation values, Nsp being the number of paths at a detected path timing and multiple timings before and after that (and for example, the case of Nsp=7 is shown in the figure), are lined up as vector elements to form a channel response.

However, since Nsp is constantly the same number (for example 7) for all detected paths, that is, a window (path residue window) with a predetermined fixed width is applied, a problem exists in that the sidelobes of a non-integer multiple symbol delay wave having a large power may not be sufficiently picked up depending on the value of Nsp, thereby resulting in a deterioration of estimation accuracy, and on the contrary, noise portions are unnecessarily picked up as paths (indicated by a reference character a), resulting in an insufficient improvement in the estimation accuracy as a recognized path group. Paths or noises in segments excepting the window (indicated by a reference character b) are replaced with zero to improve S/N ratio.

Accordingly, in the following embodiments of the present invention, a channel estimator is provided which can improve the estimation accuracy of channel response by adaptively controlling a path residue window, which is a window that specifies paths to be preserved, needed for channel response.

### First Embodiment

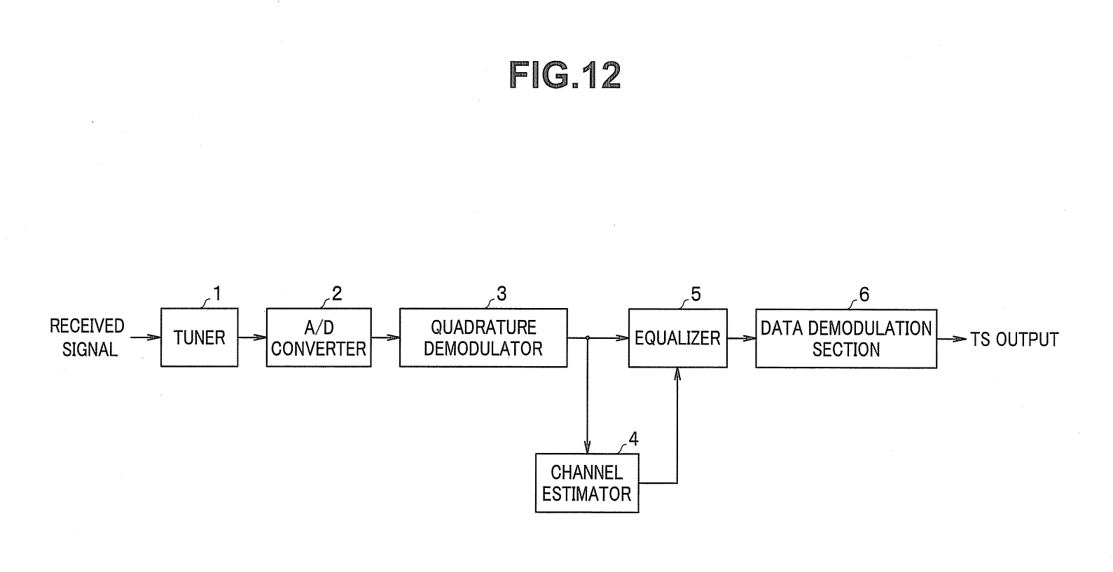

FIG. 1 is a block diagram to show the configuration of a channel estimator relating to a first embodiment of the present invention. Note that FIG. 12 shows the configuration of a common receiver in which a channel estimator that is the subject of the present invention is used.

A channel estimator 100 of the first embodiment of the present invention includes: a channel response estimation section 101 configured to estimate a channel response by correlation processing between a received signal and a known pattern signal; a noise power calculation section 102 configured to measure noise power from the channel response outputted from the channel response estimation section 101; a path power calculation section 103 configured to measure the power of each path within the output of the channel response estimation section 101; a path determination section 104 configured to determine the paths to be preserved by using the path power outputted from the path power calculation section 103 and the noise power outputted from the noise power calculation section 102; and a noise removal section 105 configured to remove values in time domain excepting residual paths determined at the path determination section 104, from the output of the channel response estimation section 101. Note that path power refers to the power of each path within a plurality of paths detected in a multi-path environment.

The channel response estimation section 101 determines a channel response by, for example, calculating a complex correlation between a received signal and a known signal sequence in time domain. In general, a channel estimator stores the calculation result of a complex time correlation sequence between a received signal r(t) and a known signal sequence (a reference signal) c(t):

[Expression 1]

∫₀^{Ts}r(t+τ)c(τ)dτ (1)

(where, Ts represents the sequence length of the known signal sequence c(t)) in a memory and places it in time series to obtain a channel response. The integration of Expression (1) can be transformed into

$$\begin{matrix}[ Expression 2 ] & \\ {\sum }_{k = 1}^{N} r ( n - k \cdot Δ t ) {c}_{k} & ( 2 )\end{matrix}$$

(where, Δt represents a sampling interval)

in a discrete time digital signal domain, and can be implemented by an FIR filter with an N-tap tapped delay line (TDL).

Moreover, as an alternative method, a channel response can be obtained by calculating a channel frequency response by performing a complex division between the spectra of the received signal and the known signal sequence in the frequency domain, and subjecting the result to an inverse Fourier transformation. For example, in a case in which a PN (Pseudo Random Noise) sequence is time-multiplexed to a transmission signal as a unique word, since the received signal is a convolution between the PN sequence and the channel response, the channel response h can be obtained by dividing the received signal that is transformed in frequency domain by the known PN and transforming the result into the time domain again.

$$\begin{matrix}[ Expression 3 ] & \\ h = IFFT [ \frac{FFT ( PN ⊗ h )}{FFT ( PN )} ] & ( 3 )\end{matrix}$$

At the noise power calculation section 102, noise power included in the channel response waveform is measured. As a specific method, for example, the whole power of the channel response waveform obtained at the channel response estimation section 101 is calculated and path powers are accumulated in the order of shorter delay times of the channel response waveform. A delayed path at the time when the accumulated value reaches X percent of the whole power is determined to be the rearmost path, and based on the judgment that only noise exists in the time domain after the delay time of the rearmost path, waveform power in this time domain is measured as noise power.

Alternatively, it is also possible to search a path having a maximum power within the channel response waveform obtained at the channel response estimation section 101; to set a power level that is relatively attenuated by Y dB with respect to the power of the maximum power path, as a threshold value; and based on the judgment that all the portions that fall short of the threshold value are noise, to measure the waveform power of this time domain as noise power. Alternatively, it is also possible to determine a path having the longest delay time within the paths exceeding the threshold value to be the rearmost path, and based on the judgment that only noise exists in the time domain further after the delay time of the rearmost path, to measure the waveform power of this time domain as noise power.

Alternatively, while an AGC (automatic gain control) function is generally implemented in a receiver, and a received radio wave is amplified or attenuated to be converted into a signal amplitude suitable for digital signal processing, noise power can also be measured by backwardly calculating from the AGC gain at the time of no signal input.

The path power calculation section 103 is configured to calculate the power of each sample of the output waveform of the channel response estimation section 101.

The path determination section 104 is configured to determine a threshold value Tn based on the noise power outputted from the noise power calculation section 102, and to determine a peak of path powers which exceed the threshold value Tn to be a path within the output of the path power calculation section 103. The threshold value Tn is determined to be the noise power value, or the same value added with a predetermined offset quantity.

The noise removal section 105 is configured to replace the values of the portions excepting the residual paths, which have been determined, with zero.

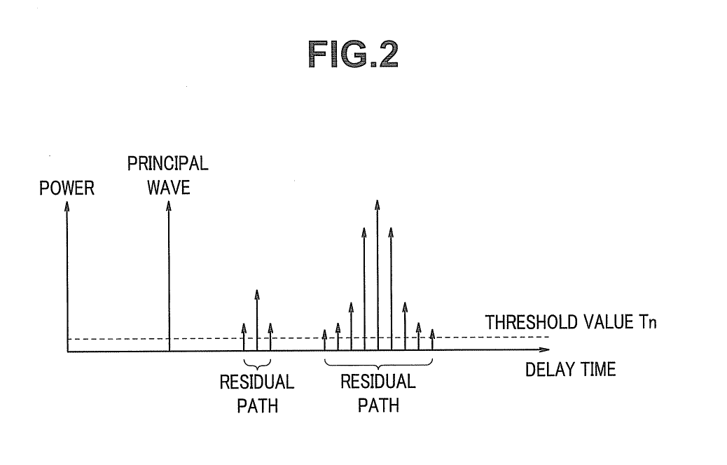

FIG. 2 shows a new channel response which is completed by a series of such processing. Paths which exceed the threshold value Tn are determined to be paths to be preserved, and the values in the time domain excepting the residual paths are removed. Since unnecessary noise is not included compared with that of FIG. 11 according to a conventional art, the S/N ratio has been improved and thereby the estimation accuracy of channel response can be improved.

According to the first embodiment, by determining paths to be preserved by using path power and noise power for a channel response, it is possible to improve the estimation accuracy of channel response.

### Second Embodiment

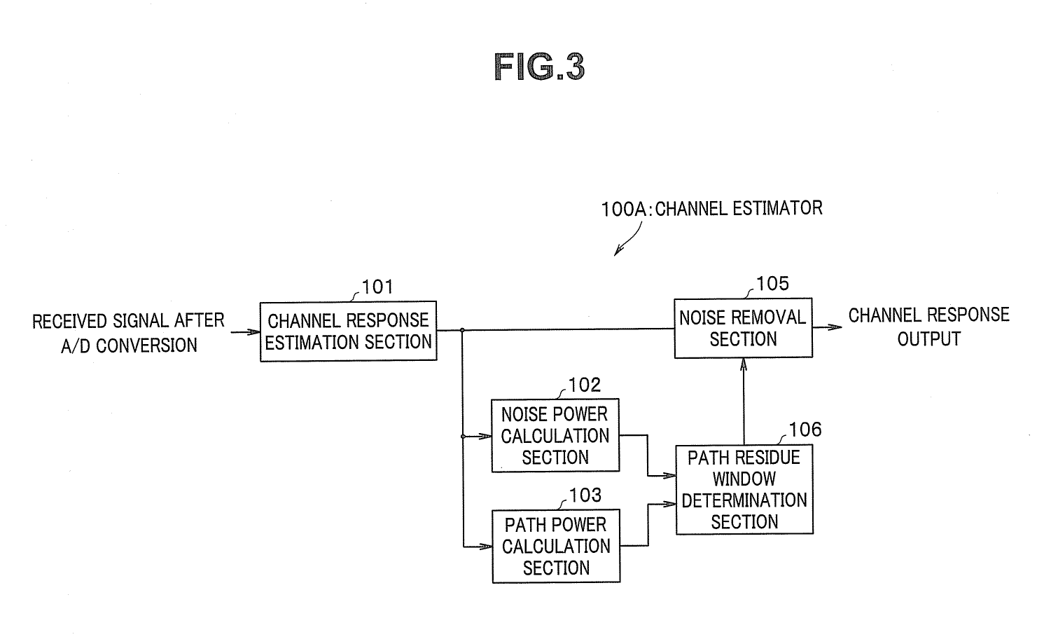

FIG. 3 is a block diagram to show the configuration of a channel estimator relating to a second embodiment of the present invention.

A channel estimator 100A of the second embodiment of the present invention includes: a channel response estimation section 101 configured to estimate a channel response by correlation processing between a received signal and a known pattern signal; a path power calculation section 103 configured to measure the power of each path within an output of the channel response estimation section 101; a noise power calculation section 102 configured to measure noise power from the output of the channel response estimation section 101; a path residue window determination section 106 configured to determine a path group to be preserved as a path residue window by using the path power outputted from the path power calculation section 103 and the noise power outputted from the noise power calculation section 102; and a noise removal section 105 configured to remove values in the time domain excepting the preserved path residue window determined at the path residue window determination section 106, from the output of the channel response estimation section 101.

Hereafter, components having the same function as that of the first embodiment will be given the same numbers thereby omitting the description thereof.

In the path residue window determination section 106, first a path group is searched in an output waveform of the channel response estimation section 101. A path group is defined as a collection of at least one or more paths which exist in a segment in which paths having power exceeding a threshold value T are successively present in time. The threshold value T is set to be the noise power value measured at the noise power calculation section 102 or the same value added to a predetermined offset quantity. Alternatively, the threshold value T to be used may be a predetermined threshold value that is relatively determined from the maximum path power of the channel response.

The path residue window determination section 106 is configured to determine a segment, in which at least one or more paths exceeding the threshold value T are successively present in time, as respective path residue window candidates, and to set a path segment exceeding the threshold value Tn out of the path residue window candidates as a path residue window, the threshold value Tn being determined according to the noise power outputted from the noise power calculation section 102.

With focus being placed on a certain path group A, the path which has the maximum power within the path group A is determined to be the center of the path residue window. Then, a total of Nsp paths are preserved before and after the window center path, and the new path group is designated by A′. Ndown paths, which fall short of the threshold value Tn which is the formerly determined noise power, are deleted out of the preserved Nsp paths. The segment of successive Nresi (=Nsp−Ndown) paths thus determined is set as a path residue window width.

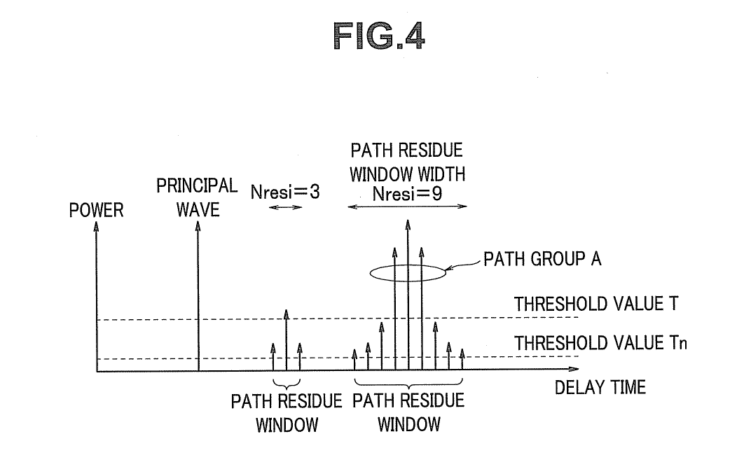

FIG. 4 shows a new channel response completed by a series of such processing. Compared with that of FIG. 11 according to the conventional art, the S/N ratio has been improved and thus the estimation accuracy of channel response can be improved.

According to the above described configuration, it is possible to improve the estimation accuracy of channel response by leaving sufficient sidelobes when the S/N ratio of the received signal is good, and by removing undesired noise components when the S/N ratio is poor, compared with a conventional method in which a threshold value determination is performed using a relative power value attenuated from the maximum path level.

Although in the above described first and second embodiments, as the conventional art, noise removal is performed by applying “zero replacement” to the outside of the path residue window thereby improving S/N ratio, a window may be applied in this portion such that smooth attenuation is attained in the outside of the path residue window. Since zero replacement is equivalent with applying a sharp rectangular window to the inside and the outside of the path residue window, an artificial discontinuity is introduced in the channel response waveform resulting in a distortion in the frequency domain response.

As a countermeasure to that, specifically, a window function represented by Blackman window and Hanning window can be applied as it is. Alternatively, a window coefficient may be used which is 1 within the path residue window and is gradually attenuated as moving away from the window boundary position in the outside of the window. Such window coefficient will smoothly remove noise.

In this way, it is possible to improve S/N ratio without distorting channel response.

According to the second embodiment, by determining a path group to be preserved as a path residue window by using path power and noise power for channel response, it is possible to improve the estimation accuracy of channel response.

### Third Embodiment

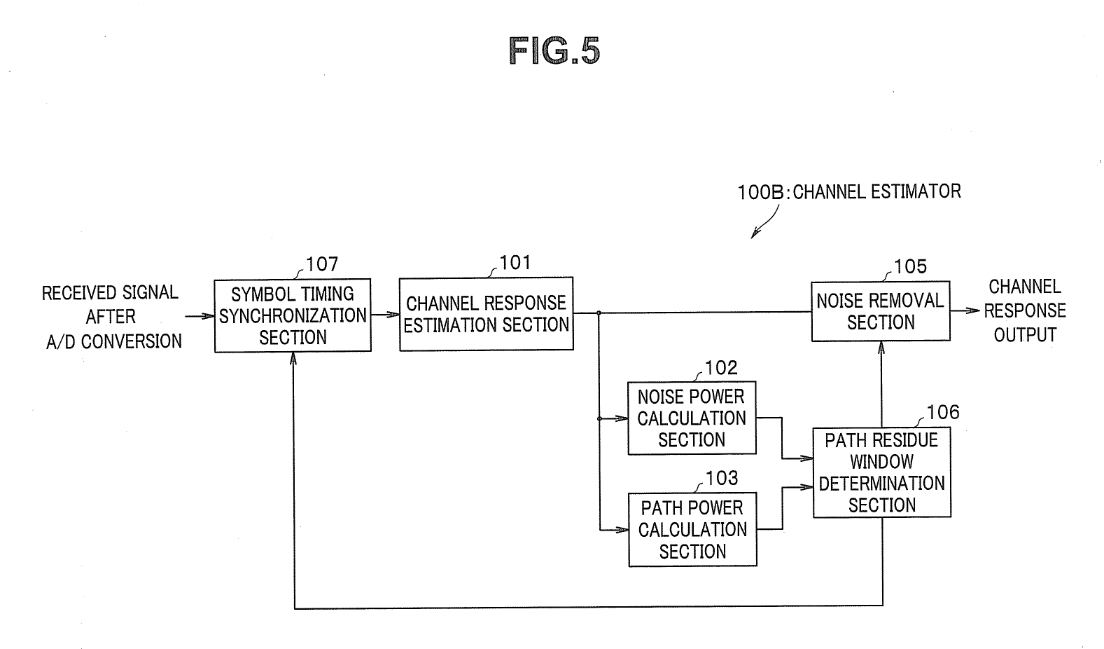

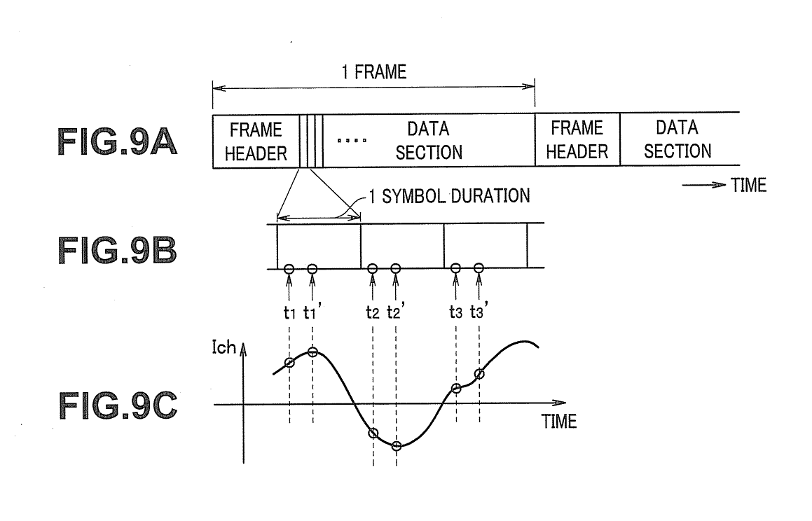

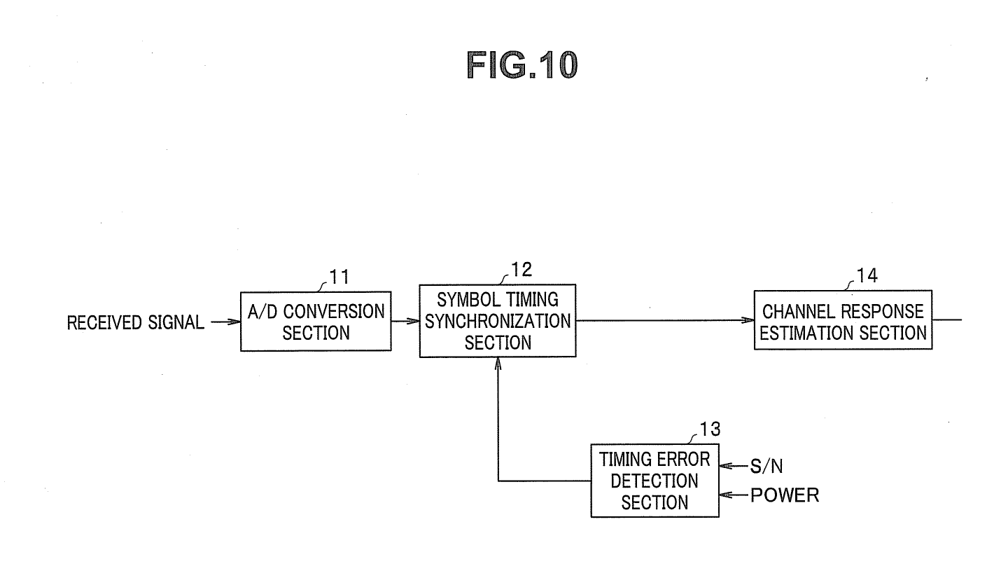

FIG. 5 is a block diagram to show the configuration of a channel estimator relating to a third embodiment of the present invention. A channel estimator 100B of the third embodiment is different from that of the second embodiment in that a symbol timing synchronization section 107 is provided in the preceding stage of the channel response estimation section 101, and the output of the path residue window determination section 106 is fed back to the symbol timing synchronization section 107. That is, a feedback is applied to the symbol timing synchronization section 107 so that the symbol synchronization timing is changed (adjusted) by the output of the path residue window determination section 106. Note that regarding the symbol synchronization timing, the background art thereof will be described later in FIGS. 9A to 9C and FIG. 10.

In a channel response, a detected path may or may not have a sidelobe depending on the sampling timing of A/D conversion. Therefore, by performing symbol timing synchronization such that the path recognized as a principal wave in a channel response does not have a sidelobe, the maximum power value of the principal wave is stabilized thereby making it easy to determine the path residue window width. In particular, this is important when determining the threshold value T in the second embodiment.

In the third embodiment, symbol synchronization timing is adjusted based on the estimation result of channel response and thereafter channel response is estimated again to perform noise removal.

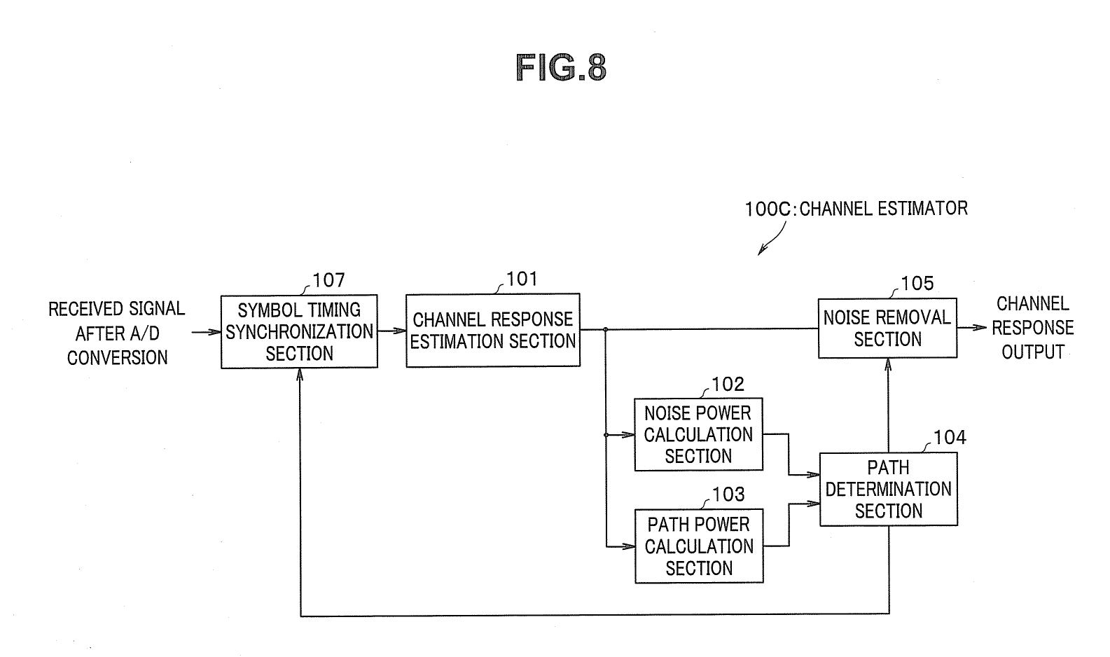

Note that in the third embodiment, although a configuration in which the symbol timing synchronization section 107 is added to the configuration of the second embodiment (FIG. 3) is shown, the configuration may be such that the symbol timing synchronization section 107 is added to the configuration of the first embodiment (FIG. 1) as shown in FIG. 8, and in that case, a feedback is performed such that the symbol synchronization timing is changed (adjusted) by the output of the path determination section 104.

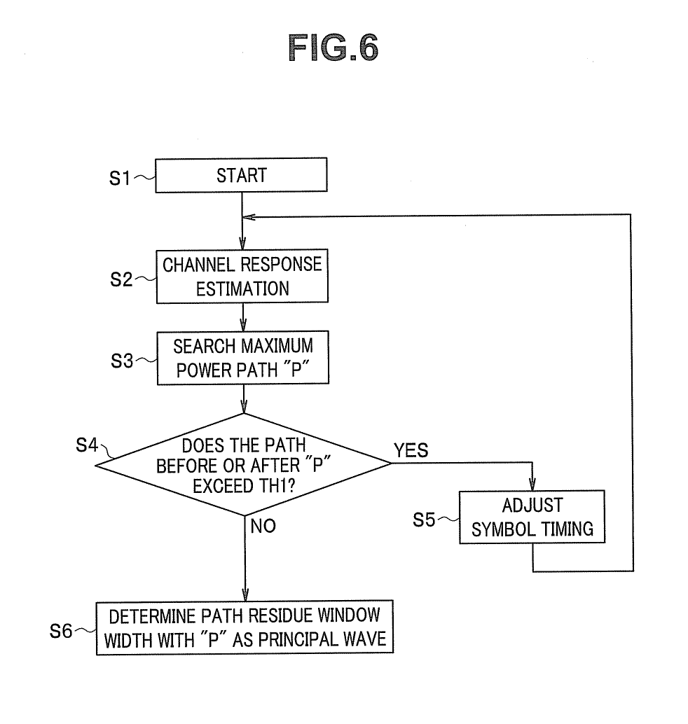

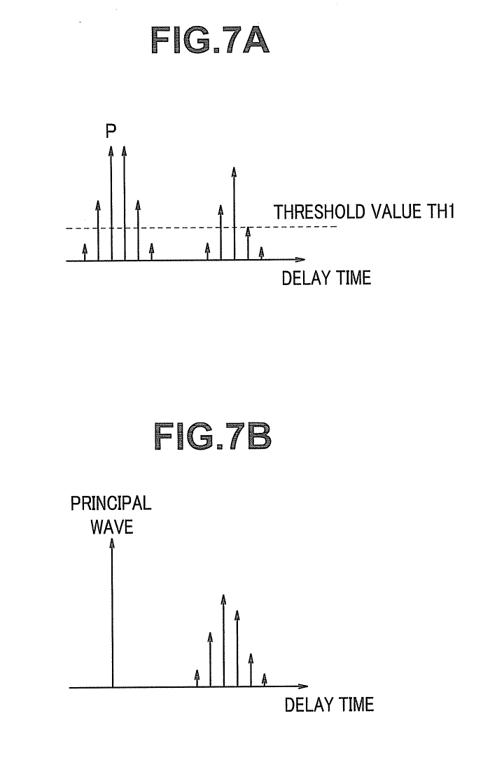

The operation of the third embodiment will be described based on the flowchart of FIG. 6 with reference to the explanatory drawings of FIGS. 7A and 7B.

FIGS. 7A and 7B are diagrams representing channel responses before and after a change of symbol synchronization timing. FIG. 7A represents a channel response before the change and FIG. 7B represents a channel response after the change.

A channel response is estimated by using a received signal which is synchronized at a symbol timing (step S1 and S2). At this time, suppose that a channel response as shown in FIG. 7A has been obtained.

Next, out of the channel responses obtained at step S2, a path P having a maximum power is searched (step S3).

In the samples before and after the timing of the path P obtained at step S3, determination is made on whether or not a path having power exceeding a predetermined threshold value TH1 exists (step S4). When no path having power exceeding the threshold value TH1 exists, the symbol timing synchronization may be left unchanged.

On the other hand, as shown in FIG. 7A, at step S4, when a path exceeding the predetermined threshold value TH1 exists before or after the timing of the path P, the symbol synchronization timing is adjusted so that P is only the path that has power exceeding the threshold value TH1 in the path group (step S5). The symbol synchronization timing (or simply symbol timing) adjustment will be described with reference to FIGS. 9A to 9C and FIG. 10. Thereafter, the channel response is estimated again (step S2). This will result in a channel response as shown in FIG. 7B and the path P has become not to produce sidelobes as the principal wave.

Thereafter, the above described path residue window width is determined with the path P being regarded as the principal wave to perform noise removal (step S6). At this moment, a separate threshold value TH2 which is defined by the relative level difference with respect to the principal wave power is determined, and a path residue window may be determined for a path group having the power exceeding TH2. TH2 may be, apart from this definition, a predetermined fixed value, or a noise power level or a value of the noise power level added with a predetermined offset quantity.

Here, the background art of the third embodiment described so far will be described. For example, taking an example of a terrestrial digital broadcasting of the People's Republic of China (hereafter, referred to as China), description will be made with reference to FIGS. 9A to 9C and FIG. 10.

In the terrestrial digital broadcasting of China, a broadcasting signal comes to be transmitted in the unit of frame. As shown in FIG. 9A, one frame is made up of, for example, 4200 symbols. One frame is made up of a frame header and a data section. The frame header is made up of a known pattern signal having, for example, 420 symbols, and the data section is made up of a data signal having, for example, 3780 symbols.

In a receiver shown in the block diagram of FIG. 10, after a radio transmission signal is received by a tuner (not shown), first, the received signal is subjected to A/D conversion at an appropriate timing in an A/D conversion section 11. The A/D conversion is performed symbol-by-symbol. With the portion of one symbol duration in the data section of FIG. 9A being enlarged as in FIG. 9B, differences may arise in the sampling amplitude value (that is the A/D conversion result) and also in the delay profile which is outputted as the multi-path characteristics from the channel response estimation section 14 in a subsequent stage, between the case in which sampling is performed at the timing of, for example, t1, t2, . . . as one symbol period when performing A/D conversion of data of one symbol duration and the case in which sampling is performed at the timing of t1′, t2′, . . . .

At that time, if the received signal has a constant envelope and a constant phase in one symbol period, sampling at any timing will do, but in reality, the received signal has been modulated and therefore it varies as shown in FIG. 9C when focusing on only an in-phase component of the signal (I ch). Therefore, because of the application of modulation, whether or not an appropriate signal value (A/D conversion value) is obtained depends on the timing of sampling at the time of A/D conversion. Since it is not possible, at the moment of sampling, to know which timing is correct, sampling is performed for the time being, and thereafter detection is made on whether or not the timing is an appropriate timing previously assumed at the timing error detection section 13, thereby performing symbol timing correction based on the detection result at the symbol timing synchronization section 12.

The timing error detection section may detect, for example, an S/N ratio and power values by using a delay profile outputted from the channel response estimation section; compare the quantity thereof with a reference value; and perform symbol timing correction at the symbol timing synchronization section in accordance with the comparison result (timing error). Here, a symbol timing correction (or symbol synchronization timing correction) refers to an adjustment (correction) to shift the timing of the sampling (A/D conversion) in one symbol period before or after in accordance with timing error.

As so far described, in FIG. 5, symbol timing synchronization will be adjusted so that the path P which is recognized as the principal wave within a channel response has no sidelobe.

The noise power calculation section 102, the path power calculation section 103, and the path residue window determination section 106 in the third embodiment (FIG. 5) are also provided with a timing error detection function for performing the symbol timing correction of the above described timing error detection section 13 (FIG. 10) in addition to the function of determining the noise removal range.

According to the configuration as described above, since the principal wave having the maximum power has no sidelobe, the maximum power (principal wave power) is stabilized without depending on the symbol synchronization timing, that is, the path recognition threshold value which is determined relatively with respect to the principal wave is stabilized thus facilitating the determination of residual path window. As a result, it becomes possible to perform effective noise removal thereby improving the estimation accuracy of channel response.

According to the third embodiment, it is possible to make the estimation of channel response more advantageous by adjusting the symbol synchronization timing.

FIG. 12 shows a block diagram of the configuration of a common receiver. The receiver shown in FIG. 12 includes: a tuner 1 configured to frequency-convert a received signal from a radio frequency band to an IF (intermediate frequency) band; an A/D converter 2 configured to perform the conversion from analog to digital signals; a quadrature demodulator 3 configured to convert the digital IF signal into a baseband signal; a channel estimator 4 which is the subject to practice the present invention; an equalizer 5 configured to equalize the received signal based on the channel response estimation result; and a data demodulation section 6 configured to demodulate the equalized data and output TS (transport stream) data. The channel estimator 4 corresponds to the channel estimator 100, 100A, or 100B in the embodiments of the present invention.

While certain embodiments have been described, these embodiments have been presented by way of example only, and are not intended to limit the scope of the inventions. Indeed, the novel systems described herein may be embodied in a variety of other forms; furthermore, various omissions, substitutions and changes in the form of the systems described herein may be made without departing from the spirit of the inventions. The accompanying claims and their equivalents are intended to cover such forms or modifications as would fail within the scope and spirit of the inventions.

What is claimed is:

1. A channel estimator, comprising:
a channel response estimation section configured to estimate a channel response by correlation processing between a received signal and a known pattern signal;
a path power calculation section configured to measure power of each path within an output of the channel response estimation section;
a noise power calculation section configured to measure noise power from the output of the channel response estimation section;
a path determination section configured to determine a path to be preserved by using the path power outputted from the path power calculation section and the noise power outputted from the noise power calculation section; and
a noise removal section configured to remove values in time domain excepting the path determined at the path determination section, from the output of the channel response estimation section.

2. The channel estimator according to claim 1, wherein
the path determination section is configured to determine a peak of the path power exceeding a first threshold value to be a path, the first threshold value being determined according to the noise power outputted from the noise power calculation section.

3. The channel estimator according to claim 1, wherein
the noise power calculation section is configured to calculate whole power of a channel response waveform obtained at the channel response estimation section, to accumulate path power in the order of shorter delay times of the channel response waveform, to determine a delayed path when the accumulated value reaches a predetermined proportion of the whole power as a rearmost path, and based on the judgment that only noise exists in a time domain further after the delay time of the rearmost path, to measure the waveform power of the time domain as noise power.

4. The channel estimator according to claim 1, wherein
the noise power calculation section is configured to search a path having a maximum power within a channel response waveform obtained at the channel response estimation section, to set a power level which is relatively attenuated by a predetermined value with respect to the power of the path of the maximum power as a threshold value, and based on the judgment that all of the portions falling short of the threshold value are noise, to measure waveform power of the time domain as noise power.

5. The channel estimator according to claim 1, wherein
the noise power calculation section is configured to determine a path having a longest delay time out of the paths exceeding the threshold value as a rearmost path, and based on the judgment that only noise exists in a time domain further after the delay time of the rearmost path, to measure waveform power of the time domain as noise power.

6. A channel estimator, comprising:
a channel response estimation section configured to estimate a channel response by correlation processing between a received signal and a known pattern signal;
a path power calculation section configured to measure power of each path within an output of the channel response estimation section;
a noise power calculation section configured to measure noise power from the output of the channel response estimation section;
a path residue window determination section configured to determine a path group to be preserved as a path residue window by using the path power outputted from the path power calculation section and the noise power outputted from the noise power calculation section; and
a noise removal section configured to remove values in time domain excepting the path residue window determined at the path residue window determination section, from the output of the channel response estimation section.

7. The channel estimator according to claim 6, wherein
the path residue window determination section is configured to determine a segment in which at least one or more paths exceeding a predetermined second threshold value are successively present in time as respective path residue window candidates, and to set a path segment exceeding a third threshold value out of the path residue window candidates as a path residue window, the third threshold value being determined according to the noise power outputted from the noise power calculation section.

8. The channel estimator according to claim 7, wherein
the path residue window determination section is configured to determine a path having a maximum power within a path group to be a center of the path residue window, the path group being a collection of at least one or more paths existent in a segment in which paths having power exceeding the predetermined second threshold value are successively located in time, and to set a continuous path segment as a path residue window width, the path segment being determined by preserving a predetermined number of paths before and after the window center path in total, and deleting paths falling short of the third threshold value out of the preserved predetermined number of paths.

9. The channel estimator according to claim 6, wherein
the noise removal section is configured to apply a predetermined window function to regions inside the path residue window and outside thereof.

10. The channel estimator according to claim 1, further comprising:
a symbol timing synchronization section configured to perform symbol timing synchronization of the received signal, wherein the symbol timing synchronization section performs timing correction based on the output of the path determination section.

11. The channel estimator according to claim 10, wherein
the timing correction by the symbol timing synchronization section is carried out such that the sampling timing in one symbol period during A/D conversion is adjusted forward or backward in time according to a timing error with respect to a predetermined reference timing.

12. The channel estimator according to claim 6, further comprising:
a symbol timing synchronization section configured to perform symbol timing synchronization of the received signal, wherein
the symbol timing synchronization section performs timing correction based on the output of the path residue window determination section.
